(19) United States
(12) Patent Application Publication
(10) Pub. No.: US 2008/0068337 A1
(43) Pub. Date: Mar. 20, 2008

(54) Inputting apparatus

(75) Inventors: Sung-Hwan Yim, Seoul (KR); Young-Su Yun, Suwon-si (KR); Wook-Hee Lee, Yongin-si (KR); Gi-Lyong Na, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/898,914

(22) Filed: Sep. 17, 2007

(30) Foreign Application Priority Data
Sep. 20, 2006 (KR) 10-2006-0091012

(51) Int. Cl. G06F 3/033

(52) U.S. Cl. 345/160

(57) ABSTRACT

An inputting apparatus for use in an electronic device, etc., that includes: a case, which has a through-hole and which forms an interior space; an upper movement key, which has a portion exposed to the exterior through the through-hole and which is movable in certain directions in a plane; an elastic member, which is secured to the case and which supports the upper movement key, such that if the upper movement key deviates from the center of the through-hole, the elastic member returns the upper movement key to the center by elastic force; and a lower movement key, which is coupled with the upper movement key with the elastic member positioned in-between, so that information may be inputted in correspondence to the movement of the upper movement key. The apparatus allows convenient manipulation and reduced overall thickness, while allowing manipulation with only a small amount of force.

### CROSS-REFERENCE TO RELATED APPLICATIONS

This application claims the benefit of Korean Patent Application No. 10-2006-0091012 filed with the Korean Intellectual Property Office on Sep. 20, 2006, the disclosure of which is incorporated herein by reference in its entirety.

### BACKGROUND

1. Technical Field

The present invention relates to an inputting apparatus.

2. Description of the Related Art

In general, a personal mobile terminal, such as a mobile phone or PDA (personal digital assistant), employs a user interface that uses a keypad. That is, a conventional mobile phone, etc., has a keypad made up of multiple buttons for inputting numbers and letters, etc., such that a user can input information, such as a telephone number or text message, etc., by pressing the buttons.

With the recent commercialization of wireless Internet services, such as the WIBRO (wireless broadband) service, etc., a window-type operating system that supports a GUI (graphical user interface) is being employed also in personal mobile terminals. An example of an operating system for the personal mobile terminal may include Windows CE, etc. Moreover, with advances in technology, personal mobile terminals are being made to offer various additional services, such as satellite broadcasting, etc., where the window-type operating system that supports a GUI is being employed also for convenient utilization of such additional services.

In accordance with the growing complexity of functions performed by the mobile terminal and with the increasing amount of information inputted, there is a need for the development of an inputting apparatus that makes it easy to input information.

### SUMMARY

An aspect of the invention is to provide an inputting apparatus which allows easy inputting and smaller size. One aspect of the invention also aims to provide an inputting apparatus which allows easy manipulation with only a small amount of force.

One aspect of the invention provides an inputting apparatus that includes: a case, which has a through-hole and which forms an interior space; an upper movement key, which has a portion exposed to the exterior through the through-hole and which is movable in certain directions in a plane; an elastic member, which is secured to the case and which supports the upper movement key, such that if the upper movement key deviates from the center of the through-hole, the elastic member returns the upper movement key to the center by elastic force; and a lower movement key, which is coupled with the upper movement key with the elastic member positioned in-between. Information may be inputted in correspondence to the movement of the upper movement key.

Embodiments of the inputting apparatus according to a certain aspect of the invention may include one or more of the following features. For example, the case may be made of a cover, in which the through-hole is formed, and a base, which is coupled to the cover. The elastic member may include a body portion, which is coupled to the upper movement key and the lower movement key, and a plurality of elastic arms formed around the body portion, where the arms may be secured by bosses formed in the base.

The arms may be positioned symmetrically with respect to the body portion, to maintain a balance between the upper movement key and the lower movement key, and the arms may branch out from the body portion in particular intervals with at least three arms supporting the body portion, to prevent the upper movement key and the lower movement key from shaking or rolling.

For easy manufacture, the body portion and the arms may be formed as a single body by performing press processing on silicone rubber, etc. Also, a magnet insertion portion, in which a magnet is inserted, may protrude out from one side of the body portion and may be inserted in the upper movement key, while a printed circuit board, on which a detection element is mounted that recognizes the movement of the magnet, may be positioned below the lower movement key.

The upper movement key and the elastic member may have at least one or more coupling holes that correspond with one another, and the lower movement key may have at least one coupling protrusion that is inserted and secured in the coupling holes, such that the lower movement key is sequentially coupled with the elastic member and the upper movement key.

A downwardly protruding portion may be formed on the other side of the elastic member, and a center hole may be formed in the lower movement key in correspondence with the protruding portion, such that the protruding portion may be inserted and secured in the center hole. The upper movement key may include a head portion, which is exposed to the exterior through the through-hole, and a body portion, which has a diameter greater than that of the head portion, with the body portion placed in contact with the inner surface of the case Furthermore, the lower movement key may be placed in contact with the printed circuit board, to prevent the lower movement key from shaking or rolling.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view illustrating an inputting apparatus according to an embodiment of the present invention in an assembled state.

FIG. 2 is a perspective view illustrating an inputting apparatus according to an embodiment of the present invention in an unassembled state.

FIG. 3 is a cross-sectional view of the inputting apparatus of FIG. 1 across line I-I′.

FIG. 4a is a schematic drawing illustrating the upper movement key positioned in the middle of the through-hole of the cover, in an inputting apparatus according to an embodiment of the present invention.

FIG. 4b is a schematic drawing illustrating the upper movement key deviating from the middle of the through-hole of the cover, in an inputting apparatus according to an embodiment of the present invention.

### DETAILED DESCRIPTION

The inputting apparatus according to certain embodiments of the invention will be described below in more detail with reference to the accompanying drawings, in which those components are rendered the same reference numeral that are the same or are in correspondence, regardless of the figure number, and redundant explanations are omitted.

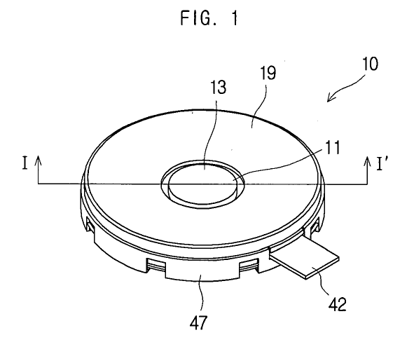

FIG. 1 is a perspective view illustrating an inputting apparatus 10 according to an embodiment of the present invention in an assembled state.

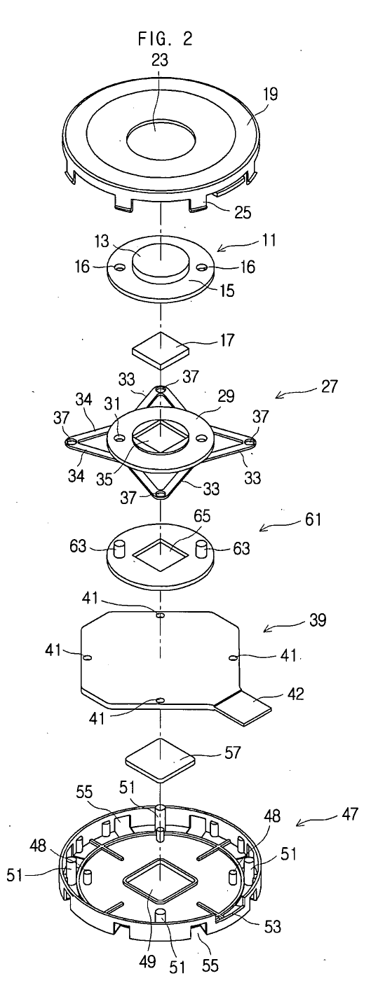

Referring to FIG. 1, an inputting apparatus 10 according to an embodiment of the invention may have a cylindrical case, composed of a cover 19 and a base 47. In the middle of the inputting apparatus 10, a portion of an upper movement key 11 may be exposed to the exterior, which may be moved in certain horizontal directions by the user. Here, a horizontal direction refers to a direction that is substantially parallel to the upper surface of the cover 19. A lead 42 may extend from inside the case of the inputting apparatus 10 to the exterior. For example, the lead 42 may extend from a printed circuit board 39 (see FIG. 2) inside the case to be connected to an external device.

As such, an inputting apparatus 10 according to an embodiment of the invention may be mounted on a mobile phone (not shown), etc., so that a pointer or cursor may be moved in certain directions in the display of a mobile phone in accordance to the movement direction of the upper movement key 11. Accordingly, inputting may be facilitated, as the user may move the upper movement key 11 in a desired direction using a finger, etc., to input information.

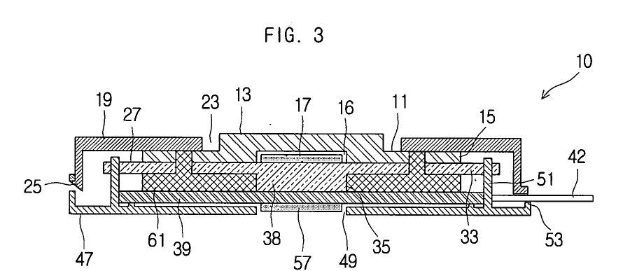

FIG. 2 is a perspective view illustrating an inputting apparatus 10 according to an embodiment of the present invention in an unassembled state, and FIG. 3 is a cross-sectional view of the inputting apparatus of FIG. 1 across line I-I′.

Referring to FIGS. 2 and 3, in an inputting apparatus 10 according to an embodiment of the invention, the cover 19 and base 47 which may form the case, may in effect form the outer body. The cover 19 and base 47 may be cylindrical in shape, and may be coupled to each other to form a cylinder-shaped column having an internal space. Inside the case may be positioned a Hall element 57, printed circuit board 39, lower movement key 61, elastic member 27, magnet 17, and upper movement key 11.

In the inputting apparatus 10 of this embodiment, the lower movement key 61 and upper movement key 11 may be movable in certain horizontal directions, while the magnet 17 may move in conjunction with the movement keys 11, 61. The movement of the magnet 17 may be sensed by the Hall element 57, which may generate a signal that causes the cursor or pointer, etc., to move. Also, if the upper movement key 11 is moved from its original position, it may be returned to the original position by the elastic force of the elastic member 27.

The elastic member 27 may be manufactured as a single body by a pressing process using elastic rubber, etc., where a body portion 29 that is coupled for concurrent movement with the upper movement key 11 may be connected by arms 33, such that after the body portion 29 moves in a certain direction, it is returned to its original state by elastic force. Thus, in the inputting apparatus 10 according to this embodiment, even if the upper movement key 11 is moved in a certain direction in a plane, the upper movement key 11 may be returned to its original state by the elastic member 27, for easy manipulation. Moreover, because the elastic member 27 may be made as a single member and may have a small thickness, the manufacture of the inputting apparatus can be facilitated, and its thickness can be reduced.

The elastic member 27 may be positioned between the upper movement key 11 and the lower movement key 61, where the coupling of the lower movement key 61, elastic member 27, and upper movement key 11 may be maintained by having coupling protrusions 63 on the lower movement key 61 inserted in the coupling holes 16 of the upper movement key 11 and the coupling holes 31 of the elastic member 27. Since the upper movement key 11 may be in contact with one side of the cover 19 and the lower movement key 61 may be in contact with one side of the printed circuit board 39, the upper movement key 11 and lower movement key 61 may be prevented from shaking.

The cover 19 may couple with the base 47 to form the case of the inputting apparatus 10. The cover 19 may have a through-hole 23 formed in the middle and multiple detent protrusions 25 protruding downward around the edge, where the detent protrusions 25 may be inserted in cover securing apertures 55 of the base 47. The detent protrusion 25, as illustrated in FIG. 3, may be shaped as a hook at one end and may be caught on a cover securing aperture 55.

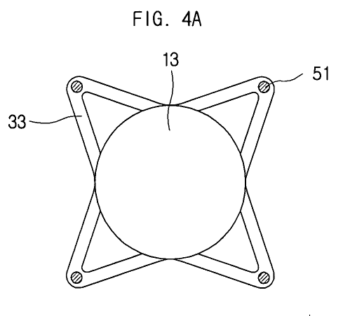

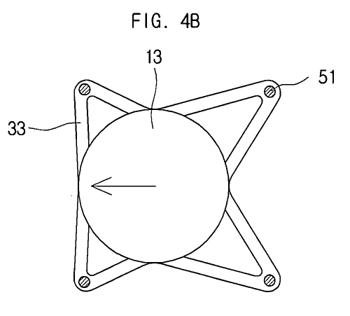

The head portion 13 of the upper movement key 11 may be exposed to the exterior through the through-hole 23 formed in the middle of the cover 19. The diameter of the through-hole 23 may be greater than the diameter of the head portion 13, so that the head portion 13 may move horizontally in certain directions inside the through-hole 23. If an external force is not applied, the upper movement key 11 may be positioned in the middle of the through-hole 23 (see FIG. 4a), and if an external force is applied and afterwards removed, the upper movement key 11 may be returned by the elasticity of the elastic member 27 to the center of the through-hole 23. As illustrated in FIG. 1, the head portion 13 of the upper movement key 11 may be exposed to the exterior through the through-hole 23, while the through-hole 23 may always be closed by the head portion 13 or body portion 15 of the upper movement key 11. Also, a buffer member (not shown), such as silicone, may be interposed between the through-hole 23 and the upper movement key 11.

While the cover 19 is illustrated in this embodiment as having a circular shape, the invention is not thus limited, and it is to be appreciated that the cover 19 may have other shapes, such as a polygonal or elliptical shape, etc., according to design considerations of the mobile terminal on which the inputting apparatus 10 is mounted. Furthermore, while this embodiment also illustrates a circular shape for the through-hole 23, the invention is not thus limited, and the shape of the through-hole 23 may vary as necessary to be given any of various different shapes, such as an elliptical shape, etc., in which case the shape of the head portion 13 of the upper movement key 11 may also correspondingly have an elliptical shape.

The upper movement key 11 may include the head portion 13, positioned in the through-hole 23 of the cover 19, and a body portion 15, formed at the bottom of the head portion 13. The upper movement key 11 may be moved in certain directions by the user, and since the magnet 17 may be moved in conjunction with the upper movement key 11, an input may be made according to the movement of the upper movement key 11.

The head portion 13 may have the shape of a cylinder having a diameter smaller than the diameter of the through-hole 23, and may have a cavity (not shown) formed on the reverse side in which a magnet insertion portion 35 may be inserted. The head portion 13 may move in certain directions inside the through-hole 23, the maximum distance that can be moved corresponding to the difference in diameters between the through-hole 23 and the head portion 13. The middle of the head portion 13, when there is no external force applied, may lie at the middle of the through-hole 23 (see FIG. 4a). The upper surface of the head portion 13 may be exposed to the exterior, as illustrated in FIGS. 1 and 3, so that when the user places a finger on the upper surface of the head portion 13 and moves it in a certain direction, the entire upper movement key 11 may move accordingly.

The body portion 15 may be formed as a single body with the head portion 13, and may have the shape of a circular plate. The bottom of the body portion 15, as illustrated in FIG. 3, may be in contact with the body portion 29 of the elastic member 27. In the body portion 15, there may be formed multiple coupling holes 16. The coupling protrusions 63 of the lower movement key 61 may be inserted through the coupling holes 31 of the elastic member 27 and into these coupling holes 16, whereby the lower movement key 61, elastic member 27, and upper movement key 11 may be coupled sequentially.

The magnet 17 positioned in the magnet-insertion portion 35 of the elastic member 27 may move in a horizontal direction together with the upper movement key 11. Since the magnetic forces generated by the magnet 17 may be sensed by the Hall element 57, a movement signal may be generated that corresponds with the movement of the magnet 17. In an inputting apparatus 10 according to the present embodiment, if the upper movement key 11 is positioned at the center of the through-hole 23, the center of the magnet 17 and the centers of the head portion 13 and through-hole 23 may coincide.

The elastic member 27 may be manufactured by press processing elastic rubber, etc., and may have a body portion 29 and arms 33 formed as a single body. The elastic member 27 may be formed from silicone rubber, as silicone rubber not only provides good molding characteristics and high tensile modulus but also provides superb durability The elastic member 27 may be secured to the base 47 and may be coupled with the upper movement key 11 to provide an elastic force, if the upper movement key 11 deviates from the original position, and thus return it to the center of the through-hole 23. The elastic member 27 can readily be manufactured by press processing, and since it may be small in thickness, the thickness of the entire inputting apparatus 10 can be reduced.

The body portion 29 may have the shape of a thin circular plate and may have a magnet insertion portion 35 in the middle protruding upward. A cavity may be formed inside the magnet insertion portion 35 in which a magnet 17 may be inserted. The perimeter of the magnet insertion portion 35 may be inserted in the cavity formed in the bottom of the upper movement key 11, whereby the upper movement key 11 and the body portion 29 may be coupled and may move together. Arms 33 may be attached to the perimeter of the body portion 29 in tangent directions. Also, as illustrated in FIG. 3, at the lower part of the body portion 29 there may be formed a protruding portion 38, which may be inserted through the center hole 65 of the lower movement key 61 for a more secure coupling between the lower movement key 61 and the elastic member 27.

The arm 33 may be composed of a pair of rods 34 branching off from the perimeter of the body portion 29 in a tangent direction, and may be shaped as a “V”. To prevent shaking, at least three arms 33 may be equipped, while FIG. 2 illustrates four arms 33 equipped in particular intervals around the body portion 29. The arms 33 may be manufactured from elastic rubber, so that if the body portion 29 deviates from its original position (the center of the through-hole 23), the arms 33 may provide elastic forces that return the body portion 29 to its original state. At the ends of the arms 33, there may be formed securing holes 37, through which bosses 51 formed on the base 47 may be inserted to secure the elastic member 27.

Since the arms 33 may be made of a pair of rods 34, the arms 33 may be contracted by the movement of the body portion 29. Thus, the arms 33 need not obstruct the movement of the body portion 29, and may prevent rolling of the body portion 29. In the case that the body portion 29 is supported by arms 33 that are each made of one rod, rolling may occur, in which the body portion 29 rotates about an axis of linearly arranged arms 33.

The printed circuit board 39 may be connected to an external control device to allow the inputting of information using input signals generated by the Hall element 57. The Hall element 57 may be attached to a lower portion of the printed circuit board 39, as illustrated in FIG. 3. In the printed circuit board 39, a plurality of securing holes 41 may be formed in which the board securing protrusions 48 of the base 47 may be inserted, whereby the printed circuit board 39 may be secured to the base 47. The printed circuit board 39 may have an upper surface in contact with the lower surface of the lower movement key 61 to undergo planar movement. Thus, rolling or shaking, etc., may be prevented for the lower movement key 61. The Hall element 57 may be attached and secured to the bottom of the printed circuit board 39, and may sense the movement of the magnet 17, which moves together with the upper movement key 11. The Hall element 57 may generate electromotive forces, in accordance with the magnetic forces generated by the magnet 17, that may be transferred through the printed circuit board 39 to an external control device (not shown).

Of course, other sensors, such as an MR sensor or a GMR sensor, may be used for the sensor element instead of the Hall element 57. The MR (magneto-resistive) sensor or the GMR (giant magneto-resistive) sensor is an element of which the resistance value is changed according to changes in the magnetic field, and utilizes the property that electromagnetic forces curve and elongate the carrier path in a solid to change the resistance. Not only are the MR sensor and GMR sensor small in size with high signal levels, but also they have excellent sensitivity to allow operation in low-level magnetic fields, and they are also superior in terms of temperature stability.

The lower movement key 61 may be shaped as a circular plate, in correspondence with the body portion 15 of the upper movement key 11, and may have a center hole 65 formed in the middle, as illustrated in FIG. 3, with the protruding portion 38 formed on the elastic member 27 inserted in the center hole 65. Also, a pair of coupling protrusions 63 may protrude upward on one side of the lower movement key 61, where the coupling protrusions 63 may be inserted through the coupling holes 31 of the elastic member 27 and the coupling holes 31 of the upper movement key 11, so that the lower movement key 61, elastic member 27, and upper movement key 11 may be coupled as one. As illustrated in FIG. 3, by having the lower surface of the lower movement key 61 be in contact with the upper surface of the printed circuit board 39, shaking may be prevented in the lower movement key 61.

The base 47, which may have the shape of a circular plate, may couple with the cover 19 to form the case, and may have an element insertion hole 49 formed in the middle. The Hall element 57 may be inserted and secured in the element insertion hole 49. Inside the base 47, there may be bosses 51, which can be inserted in the securing holes 37 of the elastic member 27, and board securing protrusions 48, which can be inserted in the securing holes 41 of the printed circuit board 39 to secure the printed circuit board 39. Also, at one side of the base 47, there may be formed a ledge 53 over which the lead 42 of the printed circuit board 39 may be extended. Around the edge of the base 47, a plurality of cover securing apertures 55 may be formed in particular intervals, on which the detent protrusions 25 of the cover 19 may be caught.

While the inputting apparatus 10 in this embodiment is illustrated as having a cylindrical case, the invention is not thus limited, and instead of being equipped with a separate case, the inputting apparatus 10 may utilize the internal space of the mobile terminal, etc., on which the inputting apparatus 10 is mounted as the case.

The operation of an inputting apparatus 10 according to certain embodiments of the invention will be described below with respect to FIG. 3, FIG. 4a, and FIG. 4b.

Referring to FIG. 3, a particular gap may be formed between the inner perimeter of the through-hole 23 of the cover 19 and the outer perimeter of the head portion 13 of the upper movement key 11. Thus, the head portion 13 of the upper movement key 11 may move in certain directions inside the through-hole 23. As the body portion 15 of the upper movement key 11 may move while in contact with the lower part of the cover 19, the upper movement key 11 may be prevented from shaking or becoming detached.

The magnet 17 may be inserted in the coupling part between the body portion 29 of the elastic member 27 and the head portion 13 of the upper movement key 11. Thus, the upper movement key 11, magnet 17, body portion 29, and lower movement key 61 may be moved as one by the user's manipulation. The body portion 29, as illustrated in FIG. 4a, may be supported by multiple arms 33 to be positioned in the middle of the through-hole 23. If the user moves the upper movement key 11 in a certain direction (in FIG. 4b, the left direction), the arms 33 positioned in the direction of movement may contract, while the arms 33 positioned on the opposite side may extend, as illustrated in FIG. 4b, to provide elastic forces on the body portion 29. As the arms 33 according to this embodiment may be in contact with the perimeter of the body portion 29 in tangent directions, the arms 33 need not obstruct movement when the body portion 29 is moved in a certain direction. In addition, as the upper movement key 11 and lower movement key 61 may be returned not by compressive forces but by tensile forces of the arms 33, a smaller amount of force is required for moving the upper movement key 11.

When the magnet 17 is moved in accordance with the movement of the body portion 29, the Hall element 57 recognizes this movement, so that an input signal can be generated in correspondence with the movement direction of the body portion 29.

As set forth above, an inputting apparatus 10 according to the present embodiment allows easy inputting, as the inputting may be performed by moving the upper movement key 11 in certain directions. Since an elastic member 27 may be used which can be formed as a single body by a pressing process, the thickness of the inputting apparatus 10 may be reduced. Also, in an inputting apparatus 10 according to this embodiment, the arms 33 that elastically support the body portion 29 may be coupled to the perimeter of the body portion 29 in tangent directions, and thus may not obstruct the movement of the body portion 29, so that a better tactile feel may be provided, and since the upper movement key 11 and lower movement key 61 may be returned by the tensile forces of the arms 33, a smaller amount of force may be required for operating the upper movement key 11.

According to certain embodiments of the invention, an inputting apparatus can be provided that allows easy inputting and smaller sizes. Certain embodiments may also provide an inputting apparatus that can be easily manipulated with a small amount of force.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An inputting apparatus comprising:
a case having a through-hole and forming an interior space;
an upper movement key having a portion thereof exposed through the through-hole to the exterior and movable in certain directions in a plane;
an elastic member secured to the case and supporting the upper movement key, the elastic member configured to return the upper movement key to a center of the through-hole by elastic force if the upper movement key deviates from the center; and
a lower movement key coupled with the upper movement key with the elastic member positioned in-between,
wherein information is inputted corresponding to a movement of the upper movement key.

2. The inputting apparatus of claim 1, wherein the case comprises a cover having the through-hole formed therein, and a base coupled to the cover.

3. The inputting apparatus of claim 2, wherein the elastic member comprises:
a body portion coupled to the upper movement key and the lower movement key; and
a plurality of arms formed around the body portion and having elasticity,
wherein the arms are secured by at least one boss formed in the base.

4. The inputting apparatus of claim 3, wherein the arms are positioned in symmetry with respect to the body portion.

5. The inputting apparatus of claim 3, wherein the arms branch out from the body portion in particular intervals and include at least three arms supporting the body portion.

6. The inputting apparatus of claim 3, wherein the body portion and the arms are formed as a single body.

7. The inputting apparatus of claim 6, wherein the elastic member is made of silicone rubber.

8. The inputting apparatus of claim 3, wherein a magnet insertion portion protrudes out from one side of the body portion and is inserted in the upper movement key, a magnet being inserted in the magnet insertion portion, and
a printed circuit board is positioned below the lower movement key, the printed circuit board having a detection element mounted thereon, the detection element configured to recognize a movement of the magnet.

9. The inputting apparatus of claim 8, wherein the lower movement key is placed in contact with the printed circuit board.

10. The inputting apparatus of claim 1, wherein the upper movement key and the elastic member have at least one or more coupling holes corresponding with one another, and
the lower movement key has at least one coupling protrusion inserted and secured in the coupling holes such that the lower movement key is sequentially coupled with the elastic member and the upper movement key.

11. The inputting apparatus of claim 10, wherein a downwardly protruding portion is formed on the other side of the elastic member, and a center hole is formed in the lower movement key in correspondence with the protruding portion, and
the protruding portion is inserted and secured in the center hole.

12. The inputting apparatus of claim 1, wherein the upper movement key comprises a head portion exposed through the through-hole to the exterior, and a body portion having a diameter greater than that of the head portion,
the body portion placed in contact with an inner surface of the case.
